(19) United States
(12) Patent Application Publication
(10) Pub. No.: US 2012/0194444 A1
(43) Pub. Date: Aug. 2, 2012

(54) Method of Tracing Touch Paths for a Multi-Touch Panel

(75) Inventors: Ching-Yang Chang, Jhudong (TW); Hsiang-Cheng Wu, Zhubei (TW)

(73) Assignee: TPK TOUCH SOLUTIONS INC.

(21) Appl. No.: 13/175,932

(22) Filed: Jul. 4, 2011

(30) Foreign Application Priority Data
Jan. 31, 2011 (CN) 201110038743.4

(51) Int. Cl. G06F 3/041

(52) U.S. Cl. 345/173

(57) ABSTRACT

A method of tracing touch paths for a multi-touch panel is disclosed. A basis touch point obtained from the multi-touch panel, a predicted touch point generated according to the basis touch point, and a detected touch point obtained from the multi-touch panel are provided. A reported touch point is then generated according to the basis touch point, the predicted touch point and the detected touch point based on a parametric curve.

### BACKGROUND OF THE INVENTION

This Application claims the benefit of People's Republic of China Application No. 201110038743.4, filed Jan. 31, 2011.

### TECHNICAL FIELD

The present invention generally relates to a touch panel, and more particularly to a method of tracing touch paths for a multi-touch panel.

### DESCRIPTION OF THE RELATED ART

A touch panel detects presence and location of a touch point typically by scanning each cell of the touch panel. However, as touch point density of the touch panel increases, it becomes difficult for processor of the touch panel to finish all the scanning in a limited time period, resulting in loss and time lag in reporting touch points.

A touch panel is susceptible to noise, which causes error or jitter in reporting touch points. Accordingly, a variety of noise-resisting filtering mechanisms performed either in spatial domain or time domain are used to suppress the noise. However, conventional noise-resisting mechanisms disadvantageously require a large memory device. Furthermore, some of such mechanisms cannot even perform effectively.

Drawbacks mentioned above become more noticeable with respect to a multi-touch panel that is capable of simultaneously registering or reporting a number of distinct touch positions. For example, noise may erroneously cause crossover between or among different traces of touch. Moreover, conventional multi-touch panels may probably mistake a trace with an abrupt turn for two distinct traces.

For the reason that a conventional multi-touch panel can not effectively report touch points and resist noise, a need has arisen to propose a method of tracing touch paths for a multi-touch panel to overcome the drawbacks.

### SUMMARY OF THE INVENTION

In view of the foregoing, it is an object of the present invention to provide a method of tracing touch paths instead of scanning all cells of a multi-touch panel, thereby accelerating detection of touch points, facilitating manufacture of high-density touch panels, correctly detecting the touch points, and effectively resisting noise.

According to one embodiment, a first touch point and a second touch point are obtained in sequence from the multi-touch panel. It is determined whether a first distance between the first touch point and the second touch point is smaller than a predefined first value. A new touch path including the first and the second touch points is then commenced if the first distance is smaller than the predefined first value. A predicted touch point is generated according to the first and the second touch points, and a detected touch point is obtained from the multi-touch panel. It is determined whether a second distance between the predicted touch point and the detected touch point is smaller than a predefined second value. A reported touch point is then generated based on the second touch point, the predicted touch point, and the detected touch points, which is further based on a parametric curve if the second distance is smaller than the predefined second value.

### BRIEF DESCRIPTION OF THE DRAWINGS

FIG. 1 shows a flow diagram that illustrates a method of tracing touch paths for a multi-touch panel according to one embodiment of the present invention; and

FIG. 2A to FIG. 2D show exemplary touch planes accompanying illustrated steps in FIG. 1.

### DETAILED DESCRIPTION OF THE INVENTION

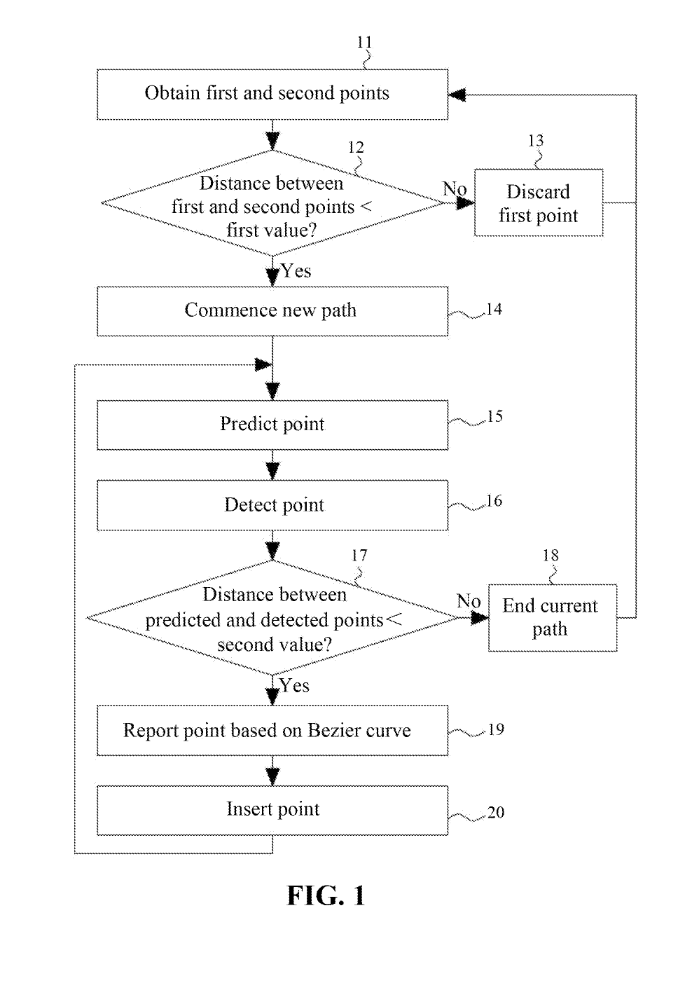

FIG. 1 shows a flow diagram that illustrates a method of tracing touch paths for a multi-touch panel according to one embodiment of the present invention. The multi-touch panel may be, but not limited to, a capacitive touch panel that measures a change in capacitance introduced, for example, by fingers. The multi-touch panel may be a stand-alone touch panel, or may be integrated with a display panel to constitute a touch screen.

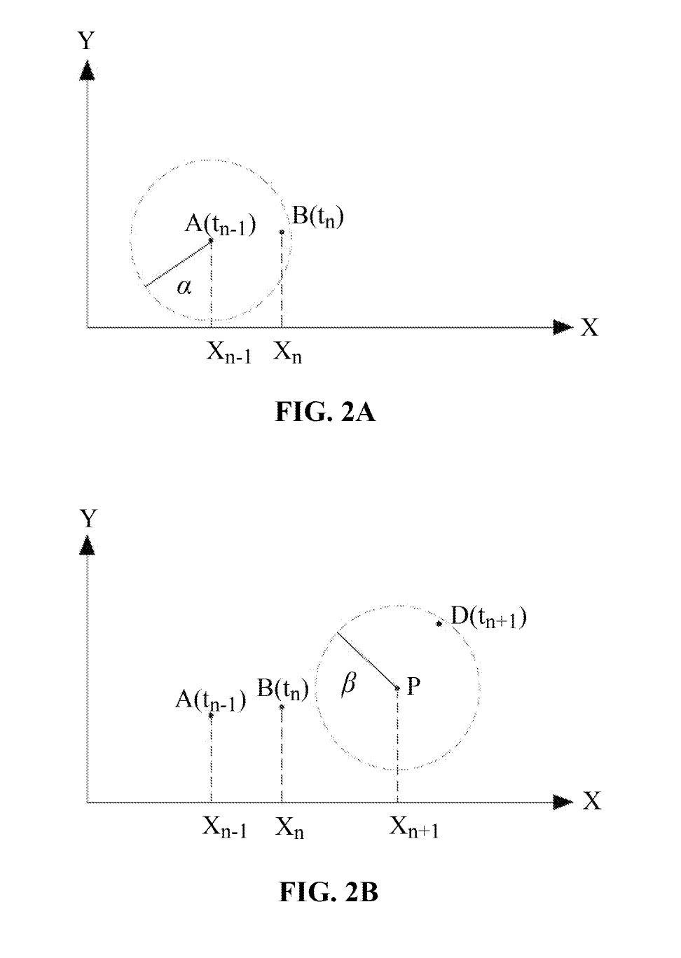

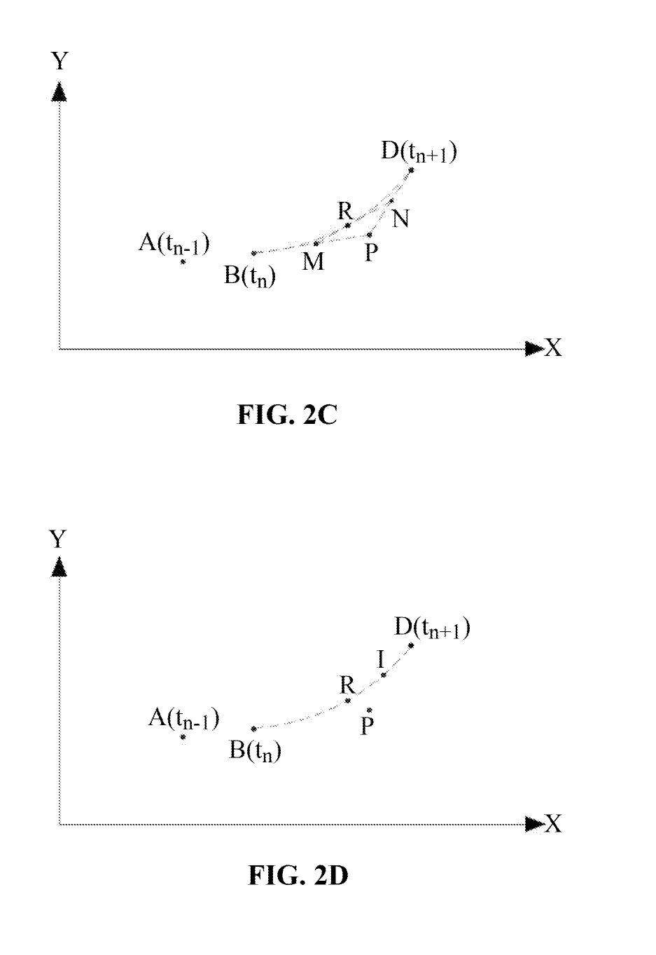

In step 11, a first touch point and a second touch point are obtained in sequence from a touch panel. The obtained first and second touch points may be stored in a memory device for later use. FIG. 2A shows a touch plane on which an exemplary first touch point A and an exemplary second touch point B are obtained at time tₙ₋₁ and tₙ respectively. For succinctness of the figure, only coordinates along X axis are shown.

Subsequently, in step 12, a first distance between the first touch point and the second touch point is determined and a check is done as to whether the first distance is smaller than a predefined first value. Generally speaking, the first distance being smaller than the predefined first value indicates that the first and the second touch points belong to the same touch path, otherwise they belong to different touch paths. As exemplified in FIG. 2A, the first distance between the point A and the point B (i.e., line segment AB) is smaller than the predefined first value α. In a case where the first distance is not smaller than the predefined first value, the first touch point is discarded as a noise (step 13) and the flow goes back to step 11, in which the second touch point is regarded as a new starting point (hereinafter “Discard”). In an alternative embodiment, the first touch point is not discarded until a predefined period has elapsed.

In case the first distance is smaller than the predefined first value, the first and second touch points commence a new touch path with a newly assigned contact identification (ID) number (step 14). As exemplified in FIG. 2A, as the first distance between the point A and the point B is smaller than the predefined first value α, the points A and B thus commence a new touch path, and a new contact ID is assigned to this touch path.

Afterwards, in step 15, a predicted touch point is generated according to previous touch points (e.g., the first and the second touch points). The generated predicted touch point may be stored in a memory device for later use. FIG. 2B shows a touch plane on which a predicted touch point P is generated according to the points A and B. In the embodiment, the position Xₙ₊₁ of the predicted touch point at an expected time tₙ₊₁ is generated according to a velocity Vₙ and an acceleration aₙ of a previous touch point at time tₙ, and may be generally expressed as follows:

Xₙ₊₁=2Vₙ*dt+aₙ*dt*dt

where

dt=tₙ₊₁−tₙ,

Vₙ=(Xₙ−Xₙ₋₁)/(tₙ−tₙ₋₁),

aₙ=(Vₙ−Vₙ₋₁)/(tₙ−tₙ₋₁)

where

Vₙ₋₁=(Xₙ₋₁−Xₙ₋₂)/(tₙ₋₁−tₙ₋₂),

Vₙ₋₁ is a velocity of another previous touch point at time tₙ₋₁, Xₙ₋₂ is a position of a further previous touch point at time tₙ₋₂. The position, velocity and acceleration along Y axis may be similarly expressed.

In step 16, a detected touch point is obtained from the touch panel. The obtained detected touch point may be stored in a memory device for later use. As exemplified in FIG. 2B, a detected touch point D is obtained at time tₙ₊₁. It is noted that the detected touch point D is commonly distinct from the predicted touch point P, for example, because of abrupt turn of the touch path or due to noise.

Subsequently, in step 17, a second distance between the predicted touch point and the detected touch point is determined to compute whether the second distance is smaller than a predefined second value. Generally speaking, the second distance being smaller than the predefined second value indicates that the detected and the predicted touch points belong to the same touch path, otherwise they belong to different touch paths. As exemplified in FIG. 2B, the second distance between the point P and the point D (i.e., line segment PD) is smaller than the predefined second value β. In case the second distance is not smaller than the predefined second value, the current touch path ends (step 18) and the flow goes back to step 11, in which the detected touch point D is regarded as a new starting point (hereinafter “End”). In an alternative embodiment, the current touch path does not end until the detected touch point has failed the test of step 17 for a predefined number of times (e.g., two times).

In case the second distance is smaller than the predefined second value, in step 19, a reported touch point is generated according to the second touch point B, the predicted touch point P and the detected touch point D based on a parametric curve such as Bezier curve. The Bezier curve is capable of resisting noise in the touch panel. FIG. 2C shows a touch plane on which a reported touch point R is generated on a Bezier curve, where the second touch point B is used as a starting point, the detected point D is used as a stopping point and the predicted touch point P is used as a controlling point. It is noted that the second touch point B in this step may in general be a basis touch point B, based on which the predicted touch point P is generated. A quadratic Bezier curve may be expressed as:

R(t)=(1−t)²B+2(1−t)tP+t²D, t=0−1

It is observed that the Bezier curve R(t) moves from point B in the direction of point P and then curves to arrive at the point D such that tangents from point B and from point D both pass through the point P. In an embodiment, when the point P coincides with the point D, parameter t is equal to 1.

According to the specific example shown in FIG. 2C, determination of parameter t and the reported touch point R are shown below:

t=1−(PD/max(BP, BD))

where PD is the line segment connecting the points P and D, BP is the line segment connecting the points B and P, and BD is the line segment connecting the points B and D,

a point M on BP is selected such that BM/BP=t,

a point N on PD is selected such that PN/PD=t,

the point R on MN is selected such that MR/MN=t.

Although a quadratic Bezier curve is illustrated for the embodiment, a higher-order Bezier curve may also be adapted to the present disclosure.

Afterwards, in step 20, one or more points may be inserted when necessary. In an embodiment, an inserted touch point may be obtained simply by selecting a parameter t of the Bezier curve obtained in step 19. FIG. 2D shows a touch plane on which an inserted touch point I is obtained on the Bezier curve between the points B and D.

While certain embodiments have been shown and described, various modifications and substitutions may be made thereto without departing from the spirit and scope of the invention. Accordingly, it is to be understood that the present invention has been described by way of illustration and not limitations.

What is claimed is:

1. A method of tracing touch paths, comprising:
providing a basis touch point obtained from a multi-touch panel,
generating a predicted touch point based on the basis touch point and a detected touch point obtained from the multi-touch panel; and
generating a reported touch point based on the basis touch point, the predicted touch point, and the detected touch point based on a parametric curve.

2. The method of claim 1, wherein the basis touch point is used as a starting point of the parametric curve, the detected touch point is used as a stopping point of the parametric curve, and the predicted point is used as a controlling point of the parametric curve.

3. The method of claim 2, wherein the parametric curve is Bezier curve.

4. The method of claim 3, wherein the Bezier curve is expressed as
R(t)=(1−t)²B+2(1−t)tP+t²D, t=0−1
wherein R is the Bezier curve on which the reported touch point is disposed, t is a parameter of the Bezier curve, B is the basis touch point, P is the predicted touch point, and D is the detected touch point.

5. The method of claim 1, further comprising a step of inserting at least one inserted touch point by selecting a parameter of the parametric curve.

6. The method of claim 1, further comprising a step of storing the basis touch point, the predicted touch point, and the detected touch point in a memory device before generating the reported touch point.

7. A method of tracing touch paths, comprising:
obtaining a first touch point and a second touch point in sequence from a multi-touch panel;
determining whether a first distance between the first touch point and the second touch point is smaller than a predefined first value;
commencing a new touch path including the first and the second touch points if the first distance is smaller than the predefined first value;
generating a predicted touch point based on the first and the second touch points;
obtaining a detected touch point from the multi-touch panel;
determining whether a second distance between the predicted touch point and the detected touch point is smaller than a predefined second value; and
generating a reported touch point based on the second touch point, the predicted touch point, and the detected touch point based on a parametric curve if the second distance is smaller than the predefined second value.

8. The method of claim 7, further comprising a step of discarding the first touch point if the first distance is not smaller than the predefined first value.

9. The method of claim 7, further comprising a step of assigning a new contact identification number to the new touch path.

10. The method of claim 7, wherein a position Xₙ₊₁ of the predicted touch point at an expected time tₙ₊₁ is generated based on velocity Vₙ, and acceleration aₙ of the second touch point at time tₙ, and is expressed as follows:
Xₙ₊₁=2Vₙ*dt+aₙ*dt*dt
where
dt=tₙ₊₁−tₙ,
Vₙ=(Xₙ−Xₙ₋₁)/(tₙ−tₙ₋₁),
aₙ=(Vₙ−Vₙ₋₁)/(tₙ−tₙ₋₁)
where
Vₙ₋₁=(Xₙ₋₁−Xₙ₋₂)/(tₙ₋₁−tₙ₋₂),
Vₙ₋₁is a velocity of another previous touch point at time tₙ₋₁, Xₙ₋₂ is a position of a further previous touch point at time tₙ₋₂.

11. The method of claim 7, further comprising a step of ending a current touch path if the second distance is not smaller than the predefined second value.

12. The method of claim 7, wherein the second touch point is used as a starting point of the parametric curve, the detected touch point is used as a stopping point of the parametric curve, and the predicted point is used as a controlling point of the parametric curve.

13. The method of claim 12, wherein the parametric curve is Bezier curve.

14. The method of claim 13, wherein the Bezier curve is expressed as
R(t)=(1−t)²B+2(1−t)tP+t²D, t=0−1
wherein R is the Bezier curve on which the reported touch point is disposed, t is a parameter of the Bezier curve, B is the second touch point, P is the predicted touch point and D is the detected touch point.

15. The method of claim 7, further comprising a step of inserting at least one inserted touch point by selecting a parameter of the parametric curve.

16. The method of claim 7, further comprising a step of storing the first touch point, the second touch point, the predicted touch point, and the detected touch point in a memory device before generating the reported touch point.
